(19) United States
(12) Patent Application Publication
(10) Pub. No.: US 2010/0275778 A1
(43) Pub. Date: Nov. 4, 2010

(54) METHOD AND AN APPARATUS FOR ABSORBING METHANE AND A METHOD OF DETERMINING AN EMISSION CREDIT

(75) Inventor: Thomas Alexander North Harttung, Barrit (DK)

Correspondence Address: KNOBBE MARTENS OLSON & BEAR LLP, 2040 MAIN STREET, FOURTEENTH FLOOR, IRVINE, CA, 92614, US

(73) Assignee: BLACKCARBON A/S, Barrit (DK)

(21) Appl. No.: 12/738,265

(22) PCT Filed: Oct. 15, 2008
(86) PCT No.: PCT/DK08/50253

§ 371 Date: Jul. 7, 2010

(30) Foreign Application Priority Data
Oct. 16, 2007 (DK) PA 2007 01492

(51) Int. Cl. B01D 53/02; F23G 5/00; F02G 1/043; G06F 19/00

(52) U.S. Cl. 95/143; 110/235; 60/517; 702/24

(57) ABSTRACT

The invention relates to a method and an apparatus for absorbing methane gas or other carbonaceous volatile gasses. The method comprises loading of solid carbonaceous matter into a vessel and loading the gas to be absorbed into the vessel. The gas is preferably formed from excrements of livestock, mainly being formed from a liquid or slurry phase of excrements of livestock. The solid carbonaceous matter is preferably formed by heating of plant material in a pyrolytic process thereby forming carbonaceous matter having a solid structure.

### FIELD OF THE INVENTION

The invention relates to a method for absorbing methane and possible other carbonaceous gasses in order to reduce emission of methane and other carbonaceous gasses characterised as greenhouse gases into the atmosphere. The invention furthermore relates to a method for determining an emission credit in a greenhouse gas sink following absorption of a greenhouse gas from excrements of livestock. The method also relates to an apparatus for the method, said apparatus comprising a pyrolytic apparatus and a vessel, preferably a closed vessel, for loading a substance containing the carbonaceous gas and for loading a carbonaceous matter, respectively, said carbonaceous matter having been formed during a pyrolytic process in the pyrolytic apparatus.

### BACKGROUND OF THE INVENTION

Negative environmental and health effects, such as global warming, smog, and respiratory problems in humans caused by the emission of harmful pollutants such as methane and carbon dioxide (CO₂), have resulted in countries, states, and territories throughout the world regulating the amount of emissions permitted by businesses and industries. Some scientists claim that the CO₂ emissions are causing global warming under the theory that the emissions create a greenhouse effect. The source of these and other emission pollutants can come from a myriad of industries such as industries breeding livestock and energy industries.

Various countries have agreed to reduce their CO₂ emissions under the Kyoto Protocol. The Kyoto Protocol is a protocol to the international Framework Convention on Climate Change with the objective of reducing greenhouse gases in an effort to prevent anthropogenic climate change.

As of May 2008, 182 parties have ratified the protocol. One hundred thirty seven developing countries have ratified the protocol, including Brazil, China and India, but have no obligation beyond monitoring and reporting emissions. Thirty six developed C.G. countries including the EU as a party in its own right are required to reduce greenhouse gas emissions to the levels specified for each of them in the treaty (representing over 61.6% of emissions from Annex I countries. The United States is the only developed country that has not ratified the treaty and is one of the significant greenhouse gas emitters. With that aim, it will provide a complex system which will allow some countries to buy emission credits from others.

The emission credits (or carbon credits) are measured in “equivalent metric tons of carbon dioxide”, the main heat-trapping gas blamed by scientists for climate change. Thus, one credit is equal to one tonne of CO₂-equivalent. This means that all other greenhouse gasses have to be converted into CO₂-equivalents.

Under the Kyoto Protocol, the Conference of the Parties decided (decision 2/CP.3) that the values of “Global Warming Potential” calculated for the IPCC Second Assessment Report are to be used for converting the various greenhouse gas emissions into comparable CO₂ equivalents when computing overall sources and sinks. GWP is a measure of how much a given mass of greenhouse gas is estimated to contribute to global warming. It is a relative scale which compares the gas in question to that of the same mass of carbon dioxide, whose GWP is by definition 1.

The Clean Development Mechanism (CDM) is an arrangement under the Kyoto Protocol allowing industrialised countries with a greenhouse gas reduction commitment (called Annex 1 countries) to invest in projects that reduce emissions in developing countries as an alternative to more expensive emission reductions in their own countries. A crucial feature of an approved CDM carbon project is that it has established that the planned reductions would not occur without the additional incentive provided by emission reductions credits, a concept known as “additionality”.

Absorbing methane and other gasses formed from excrements of livestock are known in different aspects. Also, having a substance containing the ionic constituents of the gas is known, such as liquid manure or a slurry of partly liquids, partly solid manure. Often methane and other gasses are collected in closed tanks, or the manure is added a catalyser or the like to eliminate formation of methane and/or other carbonaceous gas by electrochemical ion bonding. Forming carbonaceous solid matter in a pyrolytic process is also known. It is also known that the pyrolytic matter has voids so that the carbonaceous matter has a certain porosity. Often, a pyrolytic process is used for burning gasses formed during the pyrolytic process. The solid matter formed during pyrolysis may be disposed of, either by being burned for energy or by being recycled as fertilizer.

JP 60106889 discloses a method for making fuel from excrements of livestock by using pulverized coal. Excrements of livestock are dried by combustion exhaust gas in a drying kiln or in the sun in a greenhouse to such an extent that water content is lowered to 50% or below. The dried excrements and pulverized coal are fed to a hopper, said coal having such a particle size distribution that 30-70 wt % thereof consists of particles having a particle size of 9-150 mesh and 70-30 wt % thereof consists of particles having a particle size of 150-500 mesh. The mixture is fed from the hopper to a mixer where they are uniformly mixed with each other. The resulting uniform mixture is fed to a pelletizing or a briquetting machine to obtain a pellet or a briquette having a water content of 20% or below. The coal is pulverised in order to be able to make the pellets or briquettes.

U.S. Pat. No. 6,205,793 discloses a method and an apparatus for storing and transporting coal mine methane gas. The apparatus utilizes converted propane tankers. Standard propane tankers are filled with activated carbon or commercial carbons with a high volumetric methane adsorption capacity. The methane gas is compressed by a smaller compressor at the well and loaded into the converted tanker. At least three converted tankers are utilized in this method, one being loaded at the well, one discharging its methane gas at the end-user, and one being transported in between the well and the end-user. Utilizing the apparatus and method of storage and transportation will reduce greenhouse emissions from the mine and from the power plants, and will provide the owner and operator with numerous tax credits and clean air incentives. It also provides the public with a cheaper source of cleaner burning fuel for large public utilities and other large end-users. Activated carbon is used, said activated coal having to be formed by subjecting carbonaceous raw material to temperatures above 700° C.

### SUMMARY OF THE INVENTION

It may be seen as an object of the present invention to provide a method and an apparatus, which both gives a possibility for industries breeding livestock to increase the amount of livestock being bred without having to increase the amount of land necessary for breading the increased number of livestock, because of the increased amount of excrements produced.

This object may be obtained by a method for absorbing methane gas or other carbonaceous volatile gasses formed from organic waste material, said method comprising
loading of a solid carbonaceous matter into a vessel,
loading the volatile gas to be absorbed into the vessel,
said gas being a free constituent or a ionic constituent of an organic waste material such as excrements of livestock, preferably being a ionic constituent of a liquid phase of excrements of livestock, and
said method using carbonaceous matter as absorbent being formed by subjecting plant material to temperatures of at the maximum 700° C. in a pyrolytic process thereby forming the carbonaceous matter having a solid structure.

The method according to the invention for absorbing methane or other carbonaceous volatile gasses constituting greenhouse gasses has the advantage that the methane is absorbed in a manner where only products produced on a farm are employed in absorbing the methane.

The raw material for the pyrolysis process may be corn, straw, wood or other organic material and the manure containing the ionic constituents of the methane is formed from the excrements of the livestock. Thus, no products from outside industries are needed.

Also, the amount of carbon-dioxide produced is limited to the very lowest amount possible. Pyrolysis is a process forming a limited amount of carbon-dioxide due to the raw material not being fully burned. Also, the emission of other greenhouse gasses is also limited to the very minimum. Especially methane is about twenty times more harmful than carbon-dioxide as a pollutive greenhouse gas.

The carbonaceous matter according to the invention can function as a greenhouse gas sink, where greenhouse gas can be absorbed from excrements of livestock and stored until further processing. Simultaneously, the carbonaceous matter according to the invention can function as an inhibitor of methane and carbon dioxide forming micro bacteria in the excrements of livestock, thereby additionally reducing the discharge of the greenhouse gas into the atmosphere.

By the method according to the invention, the methane is absorbed in the carbonaceous matter formed during the pyrolysis process. The carbonaceous matter from the pyrolysis process may subsequently be burned off, thereby producing carbon-dioxide as all burning will do. Alternatively, the carbonaceous matter from the pyrolysis process may be used as a soil improving agent, e.g. as an enriched fertilizer not only having the fertilising benefits of the carbonaceous matter itself, but also having the fertilising advantages of the methane absorbed in the carbonaceous matter.

The method according to the invention may also be used by privates, by industrial entities and by governments to fulfill the Kyoto Protocol. The Kyoto Protocol is a ‘cap and trade’ system that imposes national caps on the emissions of greenhouse gasses. Although these caps are national-level commitments, in practice most countries will devolve their emissions targets to individual industrial entities, such as a farm with livestock.

The possible buyers of Credits may be privates and industrial entities that expect their emissions to exceed their quota. Typically, they will purchase Credits directly from another party with excess allowances, from a broker, or from an Energy Saving Company (ESCO).

Carbon Credits are tradable instruments with a transparent price and with a measurable amount for trading. The market is expected to grow substantially, with banks, brokers, funds, arbitrageurs, ESCOs and private traders eventually participating.

According to an aspect of the invention the method furthermore comprises
loading solid carbonaceous matter having voids within the structure of the matter so that said matter is having a porosity resulting in storage to volume ratio of at least 50 to 1, possibly of at least 100 to 1, even more possible 150 to 1, even further possible resulting in a storage to volume ratio above 180 to 1,
loading a fluid substance, i.e. a gas or a liquid, and said fluid substance containing the ionic constituents of the gas to be absorbed, into a vessel.

The porosity may be measured by different methods. One method is the so-called volume/density method. The method involves loading the solid carbonaceous matter into some kind of container of a known volume. Before loading the solid carbonaceous matter into the container, weigh the container to determine its empty weight. Load the solid carbonaceous matter into the container. Weigh the container with the solid carbonaceous matter. Subtract the weight of the container to determine the weight of just the solid carbonaceous matter. Now both the volume and the weight of the solid carbonaceous matter may be determined. The weight of the solid carbonaceous matter divided by the density of the solid carbonaceous matter gives the volume that the solid carbonaceous matter takes up, minus the pore volume. The pore volume is then determined by the following equation: Pore volume is equal to total volume minus material volume.

According to one specific feature of the above aspect of the invention the fluid substance is a gaseous substance containing the ionic constituents of the gas to be absorbed into a vessel, said gaseous substance having a viscosity of less than 20·10⁻⁶ Pa·s, measured at 0° C. and at normal atmospheric pressure.

According to another specific feature of the above aspect of the invention the fluid substance is a liquid substance containing the ionic constituents of the gas to be absorbed into a vessel, said liquid substance having a viscosity of more than 0,500·10⁻³ Pa·s, measured at 25° C. and at normal atmospheric pressure.

According to an aspect of the invention, the carbonaceous matter is used as a greenhouse gas sink, said greenhouse gas having been absorbed in or being chemically bound in excrements of livestock, and said greenhouse gas being stored until further processing, said greenhouse gas being stored in carbonaceous matter functioning as an inhibitor of methane and carbon dioxide forming micro bacteria in the excrements of livestock, thereby additionally reducing the emission of the greenhouse gas into the atmosphere.

An alternative or supplementary method according to the invention is a method for determining an emission credit in a greenhouse gas sink following absorption of a greenhouse gas from excrements of livestock,

a) said greenhouse gas sink comprising carbonaceous matter being formed during a pyrolysis process, said method comprising the steps of
b) measuring an amount of emission of greenhouse gas from a predefined amount of manure for a predefined period of time
c) measuring the amount of emission of greenhouse gas from a mixture of manure and predefined amount of said greenhouse gas sink,
d) said amount of manure and period of time being the same as in a)
e) establishing the amount of greenhouse gas capable of being stored in predefined amount of said greenhouse gas sink
f) quantifying the total reduction of emitted greenhouse gas per amount greenhouse gas sink, submerged in the manure, per amount of manure for a predefined period of time, and
g) quantifying the amount of emission credits per amount greenhouse gas sink.

According to the alternative or supplementary method of the invention, it is possible to establish, at an early stage and at a basis being possible to determine objectively, to define how many emission credits a certain amount of carbonaceous matter, when used as a greenhouse gas sink, is equivalent to.

The possible period of time, within which measuring an amount of emission of greenhouse gas from a predefined amount of manure is performed, is within the interval of 1 hour to 1 year, such as 1 hour to 3 months, such as 1 hour to 1 month, such as 6 hours to 1 year, such as 12 hours to 1 year, such as 1 week to 1 year, such as 1 month to 1 year. The choice of period of time may differ depending on different parameters individually or in combination such as: the organic waste material in question, the concentration of greenhouse gas in the organic waste material, the certainty needed or desired of the measuring being performed within the period of time and possible other parameters.

The possible amount of greenhouse gas sink is within the interval of 10 mg to 1000 metric tonnes, such as 500 mg to 1 metric tonnes, such as 1 gram to 100 kg, such as 50 gram to 10 kg, preferably the predefined amount of said greenhouse gas sink is 1 kg. The choice of amount of greenhouse gas sink may differ depending on different parameters individually or in combination such as: the organic waste material in question, the concentration of greenhouse gas in the organic waste material, the certainty needed or desired of the measuring being performed within the period of time and possible other parameters.

The possible amount of manure is within the interval of 10 mg to 1000 kg, such as 1 gram to 100 kg, such as 5 gram to 50 kg, such as 10 gram to 30 kg, preferably the predefined amount of said amount manure is 10 kg. The choice of amount of manure may differ depending on different parameters individually or in combination such as: the organic waste material in question, the concentration of greenhouse gas in the organic waste material, the certainty needed or desired of the measuring being performed within the period of time and possible other parameters.

The greenhouse gas intended for being absorbed by carbonaceous matter, when used as a greenhouse gas sink, may be a mixture of different greenhouse gases, preferably a mixture of methane and CO2, or the greenhouse gas intended for being absorbed by carbonaceous matter, when used as a greenhouse gas sink, may be one greenhouse gas only, preferably methane only.

The object of the invention may further be obtained by an apparatus for performing the method, said apparatus comprising
at least one vessel, preferably a closed container, having a first inlet for a solid carbonaceous matter being formed during a pyrolysis process taking place in the combustion chamber, and said vessel furthermore having
at least a second inlet for a substance, preferably a liquid substance being formed from organic waste material and said substance containing methane or other carbonaceous volatile gasses.

A vessel for containing both the solid carbonaceous matter and the substance containing methane or other carbonaceous volatile gasses results in a simple but yet reliable mixing of the solid carbonaceous matter and the substance containing methane or other carbonaceous volatile gasses.

The size, the shape, and whether the vessel is open or closed, depend entirely on the layout of the apparatus, on the structure and size of the solid carbonaceous matter and of the kind of carbonaceous gas or gasses being loaded into the vessel.

According to a preferred embodiment of the apparatus, where
the combustion chamber forms part of a Stirling machine with at least one group of four uniformly oriented cylinders positioned in a quadrangular arrangement, a double-acting piston arranged within each cylinder and dividing the cylinder into a warm and a cold cylinder chamber, the warm chamber of each cylinder being interconnected with the cold chamber of the succeeding cylinder in a succession of cylinders along the perimeter of the quadrangular arrangement, and
said Stirling machine comprising a combustion chamber common to said group of cylinders is arranged within or adjacent to the quadrangular arrangement of cylinders, the combustion chamber having walls defining therein closed gas spaces, the warm cylinder chamber of each cylinder of the group communicating with one end region of at least one of said gas spaces, which at the opposite end region communicates with the cold cylinder chamber of the succeeding cylinder through at least one heat regenerator and at least one cold space, and

Providing a Stirling machine for the pyrolysis process has the advantage that the pyrolysis process itself may produce energy while forming the solid carbonaceous matter for the method according to the invention. Furthermore, a Stirling machine is a reliable and easy-to-repair machine, which may be beneficial in relation to limit need of control of the machine and at locations where technical assistance during possible breakdown is limited, such as in third countries

According to a preferred solid carbonaceous matter, the solid carbonaceous matter is being formed during a pyrolysis process of plant raw material, possibly raw material from wood such as conifer, even possibly raw material from crops such as maize, even more possibly raw material from organic waste material. Selecting raw material which is derived from plants results in a farm possible having the raw material ready at hand for performing the pyrolysis process for forming the solid carbonaceous matter for the method according to the invention.

According to a preferred substance containing methane or other carbonaceous volatile gas, the substance being formed from organic waste material, said substance containing methane or other carbonaceous volatile gasses, is formed from excrements from livestock such as liquid manure, alternatively is formed from garbage such as domestic refuse, even in the alternative is formed from industrial waste such as offal.

Selecting a substance containing methane or other carbonaceous gasses from excrements of livestock results in a farm being able, at first hand, to reduce emission of greenhouse gasses by the method according to the invention.

### BRIEF DESCRIPTION OF THE DRAWINGS

The invention will hereafter be described with reference to the drawings where

FIG. 1 is a photograph showing two different kinds of carbonaceous matter,

FIG. 2 is a photograph showing experimental setup with carbonaceous matter and liquid manure as the substance containing ionic constituents of methane to be absorbed,

FIG. 3 is a first chart showing experimental results from the experiments performed in the experimental setup shown in FIG. 2,

FIG. 4 is a second chart showing experimental results from the experiments performed in the experimental setup shown in FIG. 2,

FIG. 5 is a third chart showing experimental results from the experiments performed in the experimental setup shown in FIG. 2,

FIG. 6 is a fourth chart showing experimental results from the experiments performed in the experimental setup shown in FIG. 2.

### DETAILED DESCRIPTION OF THE INVENTION

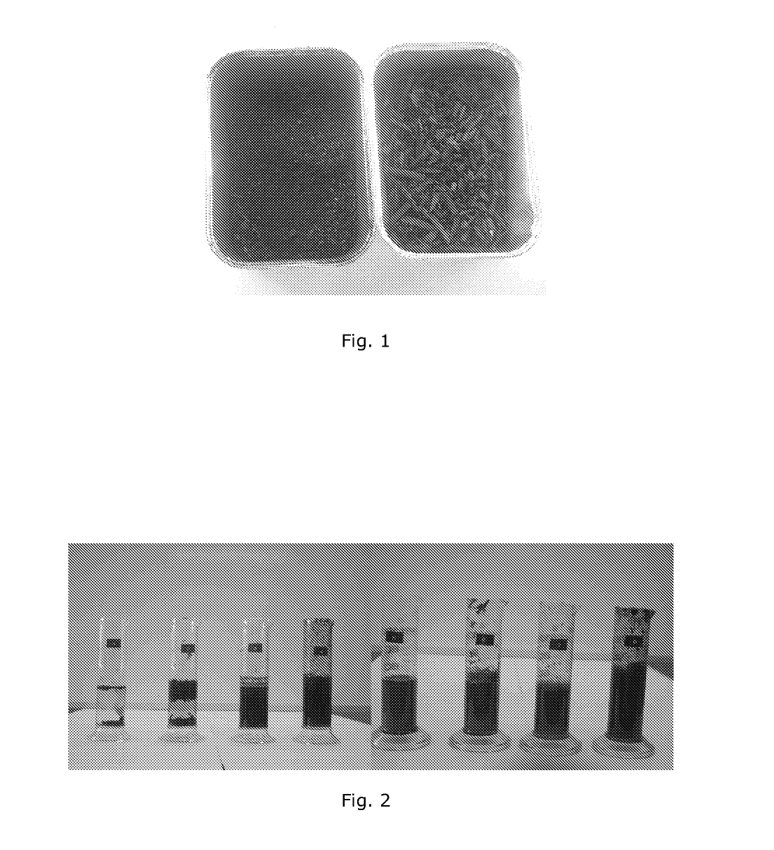

FIG. 1 shows two different sizes of solid carbonaceous matter obtained by a pyrolysis process. The raw material of the pyrolysis process is pine wood and the solid carbonaceous matter is coke having a largest size of 5 mm (to the left, called Coke1) and having a size generally larger than 5 mm (to the right, called Coke2).

The apparatus for performing the pyrolysis process is preferably an apparatus incorporating a Stirling machine as the one described in international patent application WO97/03283, the content of which is hereby incorporated by reference.

According to the Stirling machine of WO97/03283, the Stirling machine may comprise at least four, and possibly eight, twelve or any other multiple of four cylinders which are aligned in two parallel, transversely spaced rows so as to define one or more quadrangular arrangement of cylinders.

Preferably, a double-acting piston is arranged within each cylinder and dividing the cylinder into a warm and a cold cylinder chamber, the warm chamber of each cylinder being interconnected with the cold chamber of the succeeding cylinder in a succession of cylinders along the perimeter of the quadrangular arrangement.

A combustion chamber common to a group of four, eight or more cylinders may then be arranged within, above, below or adjacent to each quadrangular arrangement of cylinders, whereby heat from the combustion chamber may effectively be transferred to the warm chambers of the cylinders. Each combustion chamber may have walls defining therein closed gas spaces, the warm cylinder chamber of each cylinder of the group communicating with one end region of at least one of said gas spaces, which at the opposite end region communicates with the cold cylinder chamber of the succeeding cylinder through at least one heat regenerator and at least one cold space.

The Stirling machine may be arranged upside down with the combustion chamber for burning wood chips arranged below the cylinders and the machines being part of a domestic heating and possibly also electricity generation installation, or even being part of a combined district heating and electricity generation installation. The sizes of the Stirling machines in which the apparatus according to the invention can be embodied are not limited to any range as the principles can be applied to all sizes of such machines. A proposed size, however not limiting the possible size, of a Stirling Machine for domestic use is between 40 kW and 150 kW.

FIG. 2 shows experimental setups where demineralised water and coke are mixed (left hand photograph) and where liquid manure and coke are mixed (right hand photograph). In Table 1, the weight amounts of demineralised water, of liquid manure and of Coke1 or Coke2, respectively, are listed.

TABLE 1

| | | Water (g) | Manure (g) | Coke1 (g) | Coke2 (g) |
|---|---|---|---|---|---|
| 1 | Water + Coke1 | 10 | — | 0.5 | — |
| 2 | | 10 | — | 5.0 | — |
| 3 | Water + Coke2 | 10 | — | — | 0.5 |
| 4 | | 10 | — | — | 5.0 |
| 5 | Manure + Coke1 | — | 10 | 0.5 | — |
| 6 | | — | 10 | 5.0 | — |
| 7 | Manure + Coke2 | — | 10 | — | 0.5 |
| 8 | | — | 10 | — | 5.0 |

### Experiment 1

The glasses are loaded with the amounts listed in table 1. The top of the glasses are sealed and the glasses are turned upside down several times. The glasses are left for two hours. Some of the solid carbonaceous matter, i.e. Coke1 and Coke2, is floating on top of the demineralised water and the liquid manure.

### Experiment 2

Different bottles (100 ml) are loaded with either demineralised water or a liquid fraction of hog manure. Solid carbonaceous matter, Coke1 or Coke2, is also loaded into the different bottles. In Table 2, the weight amounts of demineralised water, of liquid manure and of Coke1 or Coke2, respectively, are listed.

TABLE 2

| | | | Manure | Coke1 | Coke2 |
|---|---|---|---|---|---|
| | | Water (g) | (g) | (g) | (g) |
| 1 | Blind | 50 | — | — | — |
| 2 | | 50 | — | — | — |
| 3 | Manure − coke | — | 50 | — | — |
| 4 | | — | 50 | — | — |
| 5 | Manure + Coke1 | — | 50 | 0.5 | — |
| 6 | | — | 50 | 0.5 | — |
| 7 | | — | 50 | 1.0 | — |
| 8 | | — | 50 | 1.0 | — |
| 9 | | — | 50 | 5.0 | — |
| 10 | | — | 50 | 5.0 | — |
| 11 | Manure + Coke2 | — | 50 | — | 0.5 |
| 12 | | — | 50 | — | 0.5 |
| 13 | | — | 50 | — | 1.0 |
| 14 | | — | 50 | — | 1.0 |
| 15 | | — | 50 | — | 5.0 |
| 16 | | — | 50 | — | 5.0 |

All bottles are made oxygen free by evacuating and refilling with helium. Analyses are performed for measuring the volumetric and/or the weight-based amount of methane, of oxygen and of carbon-dioxide. The analyses are performed on the same day as the bottles are filled and the day after the bottles have been filled. Different apparatuses are used for measuring the different amounts. The Shimadzu GC is used for measuring methane, and the Agilent micro GC is used for measuring oxygen and carbon-dioxide. Both instruments are running constantly within the period of one day. As a reference, the amount of atmospheric air is measured before each measurement of methane, of oxygen and of carbon-dioxide.

FIG. 1 shows the amount of methane within the different bottles in one day (a period of approximately two hours). It is evident that there is a reduced formation of methane as a function of the weight amount of coke added to the manure and depending on whether it is Coke1 or Coke2 which is added to the manure, when compared with manure without coke being added.

Subsequent to the measurements having been performed as shown in FIG. 1, the bottles are opened so that the bottles are allowed access to the oxygen-containing atmosphere. Thereby, the experiments are more like real conditions.

After three days, and also after eight days, of standing during oxygen-containing atmosphere, the bottles are closed for a period of two to three hours. The concentration of carbon-dioxide, of oxygen and of methane is measured at the start and at the end of the period.

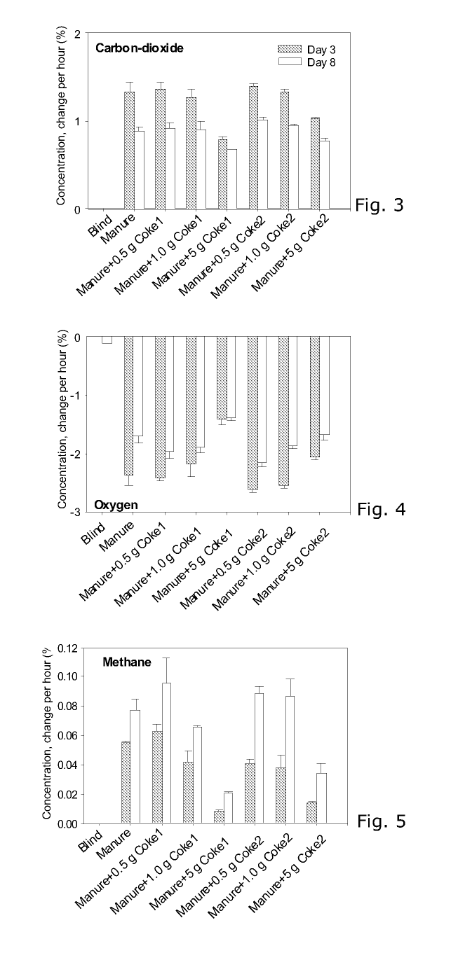

FIG. 2 shows, within the period of two to three hours, the change per hour in concentration of carbon-dioxide, FIG. 3 shows, within the period of two to three hours, the change per hour in concentration of oxygen, and FIG. 5 shows, within the period of two to three hours, the change per hour in concentration of methane.

The results are in general the same for each of the two measurements, i.e. on day 3 and on day 8. However, the general pattern of the results is different in relation to carbon-dioxide and oxygen and in relation to methane.

The micro-bacterial activity seems to drop between the results of day 3 and day 8, respectively. It is indicated by less formation of carbon-dioxide and less absorption of oxygen per hour. The effect of the coke is evident.

The level of speed for the formation of methane increased between day 3 and day 8. It may be a due to a stimulation of methane-forming bacteria in all bottles.

The results shown in FIG. 3, FIG. 4 and FIG. 5 generally show an inhibition of micro-bacterial activity in bottles with highest concentration of coke in the manure, i.e. approximately 10% weight coke). It is indicated both on the formation of carbon-dioxide and on the absorption of oxygen, both of which is an indication of the overall respiration of the micro-bacteria.

The bottle with manure without coke added shows a higher concentration of carbon-dioxide and a higher absorption of oxygen than the bottles with coke added.

Methane is also inhibited, and the inhibition of methane is more profound than for the general micro-bacterial respiration, in the order 80% in the bottles added Coke1 and in the order of 65% in the bottles added Coke2. The effect is the same after day 3 and after day 8.

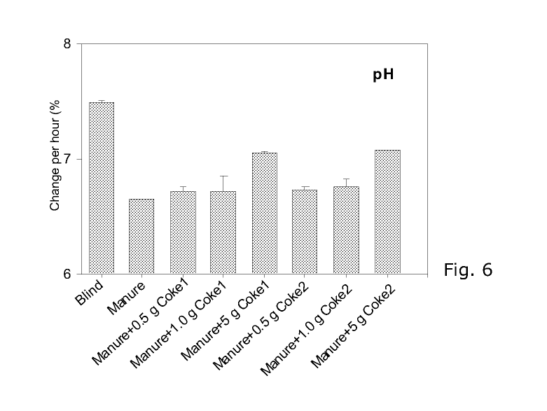

pH are measured in all samples on day 2. The results of the measurements are shown in FIG. 6. The samples added a weight amount of coke of approximately 10% show very different results compared to the other samples, although the absolute differences in pH are so small, that the differences in pH not in themselves can explain the inhibition in concentration of methane of between 65% and 80%.

1. A method for absorbing methane gas or other carbonaceous volatile gasses formed from an organic waste material comprising:
loading a solid, absorbent carbonaceous matter into a vessel, wherein said carbonaceous matter comprises voids within the structure of the carbonaceous matter so that said carbonaceous matter has a porosity and, wherein said carbonaceous matter is formed by subjecting plant material to temperatures of at the maximum 700° C. in a pyrolytic process; and
loading the organic waste material in a liquid form into the vessel, said liquid form containing ionic constituents of the gas that is to be absorbed.

2-22. (canceled)

23. The method according to claim 1, wherein said organic waste material is an excrement of livestock.

24. The method according to claim 1, wherein the amount and porosity of said solid, absorbent carbonaceous matter is sufficient to provide a storage to volume ratio of at least 50 to 1.

25. The method according to claim 24, further comprising loading a gaseous substance containing the ionic constituents of the gas to be absorbed into the vessel, said gaseous substance having a viscosity of less than 20×10⁻⁶ Pa·s, measured at 0° C. and at normal atmospheric pressure.

26. The method according to claim 24, further comprising loading a liquid that contains the ionic constituents of the gas to be absorbed into said vessel, wherein said liquid has a viscosity of more than 0.500×10⁻³ Pa·s, measured at 25° C. and at normal atmospheric pressure.

27. The method according to claim 24, further comprising loading a gaseous substance that contains the ionic constituents of the gas to be absorbed into said vessel such that the weight ratio between the gaseous substance and the solid, absorbent carbonaceous matter, after having been loaded into the vessel, is at least 5%.

28. The method according to claim 24, wherein the solid, absorbent carbonaceous matter is less than 25 mm in size and, wherein the weight ratio between the solid, absorbent carbonaceous matter and the organic waste material in liquid form after having been loaded into the vessel is at least 2%.

29. An apparatus comprising at least one vessel that comprises:
a combustion chamber;
a first inlet that is configured to receive a solid, absorbent carbonaceous matter formed during a pyrolysis process taking place in the combustion chamber; and
a second inlet configured to receive an organic waste material that contains methane or a carbonaceous volatile gas.

30. The apparatus according to claim 29, wherein the combustion chamber forms part of a Stirling machine that comprises:
at least one group of four uniformly oriented cylinders positioned in a quadrangular arrangement;
a double-acting piston arranged within each cylinder and dividing the cylinder into a warm and a cold cylinder chamber, wherein the warm chamber of each cylinder is interconnected with the cold chamber of the succeeding cylinder in a succession of cylinders along the perimeter of the quadrangular arrangement, wherein said combustion chamber is common to said group of cylinders and is arranged within or adjacent to the quadrangular arrangement of cylinders, wherein the combustion chamber has walls defining therein closed gas spaces, and wherein the warm cylinder chamber of each cylinder of the group communicates with one end region of at least one of said gas spaces, which at the opposite end region communicates with the cold cylinder chamber of the succeeding cylinder through at least one heat regenerator and at least one cold space.

31. The apparatus according to claim 29, wherein the solid, absorbent carbonaceous matter is a plant material.

32. The apparatus according to claim 29, wherein the organic waste material comprises an excrement from livestock, garbage or industrial waste.

33. The method according to claim 23, wherein the carbonaceous volatile gas is a greenhouse gas.

34. A method for determining an emission credit in a greenhouse gas sink following absorption of a greenhouse gas from an excrement of livestock comprising:
a) providing a greenhouse gas sink, said greenhouse gas sink comprising a carbonaceous matter that is formed during a pyrolysis process;
b) measuring an amount of emission of a greenhouse gas from a predefined amount of manure for a predefined period of time;
c) measuring the amount of emission of a greenhouse gas from a mixture of manure and predefined amount of said greenhouse gas sink, said amount of manure and period of time being the same as in b);
d) establishing the amount of greenhouse gas capable of being stored in a predefined amount of said greenhouse gas sink;
e) quantifying the total reduction of emitted greenhouse gas per amount greenhouse gas sink, submerged in the manure, per amount of manure for a predefined period of time; and
f) quantifying the amount of emission credits per amount greenhouse gas sink.

35. The method according to claim 34, wherein the predefined period of time is within 1 hour to 1 year.

36. The method according claim 34, wherein the predefined amount of said greenhouse gas sink is within 10 mg to 1000 metric tons.

37. The method according to claim 34, wherein the predefined amount manure is within 10 mg to 1000 kg.

38. The method according to claim 34, wherein the greenhouse gas is a mixture of methane and CO₂.

39. The method according to claim 34, wherein the greenhouse gas is methane.

40. The method according to claim 34, wherein the amount and porosity of said solid, absorbent carbonaceous matter is sufficient to provide a storage to volume ratio of at least 50 to 1.

41. The method according to claim 34, wherein said carbonaceous matter is less than 25 mm in size.

42. The method according to claim 40, wherein said carbonaceous matter is less than 25 mm in size.

43. The method according to claim 34, wherein said carbonaceous matter is being formed during a pyrolysis process of plant raw material.
